(19) United States
(12) Patent Application Publication
(10) Pub. No.: US 2003/0206146 A1
(43) Pub. Date: Nov. 6, 2003

(54) Liquid crystal display apparatus

(75) Inventors: Tsukasa Yagi, Kobe-Shi (JP); Shuji Yoneda, Osaka-Shi (JP); Naoki Masazumi, Kobe-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO. , LTD. ,

(21) Appl. No.: 09/821,359

(22) Filed: Mar. 29, 2001

(30) Foreign Application Priority Data
Mar. 31, 2000 (JP) 2000-096606

(51) Int. Cl. G09G 3/36

(52) U.S. Cl. 345/87; 345/212

(57) ABSTRACT

A liquid crystal display apparatus which carries out matrix driving of liquid crystal by applying voltages to a plurality of scan electrodes and a plurality of data electrodes which face and cross each other with the liquid crystal in-between. The drive of the liquid crystal to make a display is controlled by a control circuit which controls a scan electrode driving circuit for driving the scan electrodes and a data electrode driving circuit for driving the data electrodes. The scan electrode driving circuit encodes and decodes a clock signal outputted from the control circuit so as to apply a stream of pulses to each of the scan electrodes at specified timings.

This application is based on Japanese patent application No. 2000-96606 filed in Japan, the contents of which are hereby incorporated by reference.

### BACKGROUND OF THE INVENTION

1. Field of the Invention

The present invention relates to a liquid crystal display apparatus, and more particularly to a liquid crystal display apparatus which carries out matrix driving of liquid crystal by applying voltages to a plurality of row electrodes and a plurality of column electrodes which face each other and cross each other at a right angle.

2. Description of Related Art

In recent years, reflective type liquid crystal displays which use liquid crystal which exhibits a cholesteric phase at room temperature such as chilral nematic liquid crystal are developed to be used as media for reproducing digital information as visual information because such liquid crystal displays consume little electric power and can be fabricated at low cost. However, such a liquid crystal display which uses liquid crystal with a memory effect has a demerit that the driving speed is low.

In order to solve this problem, in U.S. patent application identified by the attorney docket No. 15162/03290, the applicants suggested an improved method of driving a liquid crystal display of this kind. By this driving method, it is possible to drive this kind of liquid crystal at a high speed with a low voltage. However, the driving circuit for driving the scan electrodes must be controlled very complicatedly, and the control circuit for controlling the scan electrode driving circuit and the data electrode driving circuit has much burden. Especially when a large-scale screen is to be driven or when varieties of control circuits are to be developed, complicated and large-scale circuits must be developed, which results in an increase in cost and a prolongation of the development. Thus, the liquid crystal display must be improved more.

### SUMMARY OF THE INVENTION

An object of the present invention is to provide a liquid crystal display apparatus in which a control circuit for a drive of liquid crystal has less burden.

In order to attain the object, a liquid crystal display apparatus according to the present invention comprises: a liquid crystal display which comprises liquid crystal, and a plurality of scan electrodes and a plurality of data electrodes which face and cross each other with the liquid crystal in-between, the scan electrodes and the data electrodes defining a plurality of display units; a scan electrode driving circuit which is connected to the scan electrodes and which outputs a stream of first pulses to each of the scan electrodes; a data electrode driving circuit which is connected to the data electrodes and which outputs a stream of second pulses to each of the data electrodes; and a control circuit which is connected to the scan electrode driving circuit and the data electrode driving circuit to control the scan electrode driving circuit and the data electrode driving circuit, the control circuit outputting a clock signal to the scan electrode driving circuit. In the liquid crystal display apparatus, the scan electrode driving circuit controls output timings of the first pulses to each of the scanning electrodes based on the clock signal.

In the display apparatus, the scan electrode driving circuit may control the output timings of the first pulses to each of the scan electrodes by encoding the clock signal in accordance with a first rule and by decoding the encoded clock signal in accordance with a second rule.

In the liquid crystal display apparatus, the scan electrode driving circuit incorporates a scheduler which controls the schedule to apply pulses to each of the scan electrodes at specified intervals as a hardware. Accordingly, the control circuit does not need to carry out complicate schedule control and can be of a simple structure. Even when driving a large-scale display, it is not necessary to develop a complicate large-scale control circuit, which reduces the cost and shortens the time for development.

In the liquid crystal display apparatus according to the present invention, it is the best to use liquid crystal which exhibits a cholesteric phase and which is capable of displaying an image thereon continuously after stoppage of application of an electric field thereto. In this case, the advantages of this kind of liquid crystal, namely, consuming little electric power and being fabricated at low cost can be used effectively.

Also, when liquid crystal which exhibits a cholesteric phase is used in the liquid crystal display apparatus according to the present invention, it is preferred that the stream of first pulses is applied to each of the scan electrodes during the following steps: a first step of causing the liquid crystal to come to a homeotropic state; a second step, after the first step, of selecting a planar state, a focal-conic state or an intermediate state between the planar state and the focal-conic state as a final state of the liquid crystal; and a third step, after the second step, of causing the liquid crystal to evolve to the selected final state. By driving the liquid crystal in the first, second and third steps in this way, an image can be written on the liquid crystal at a relatively high speed.

The number of first pulses to be outputted during at least one of the first, second and third steps may be set outside the scan electrode driving circuit or may be set as a fixed value beforehand in the scan electrode driving circuit. In the former case, it is easy to change the number, and in the latter case, the structure of the control circuit is simpler.

### BRIEF DESCRIPTION OF THE DRAWINGS

This and other objects and features of the present invention will be apparent from the following description with reference to the accompanying drawings, in which:

FIG. 1 is a sectional view of an exemplary liquid crystal display employed in a liquid crystal display apparatus according to the present invention;

FIG. 2 is a block diagram which shows a driving circuit of the liquid crystal display;

FIG. 3 is a chart which shows a fundamental driving waveform used in a method of driving the liquid crystal display;

FIG. 4 is a chart which shows a driving waveform in a selection step of the driving method;

FIG. 5 is a chart which shows pulse waveforms applied to scan electrodes and a column electrode and driving waveforms which act on pixels;

FIG. 6 is a chart which shows basic clock signals for a scan electrode driving IC;

FIG. 7 is a chart which shows basic clock signals for a data electrode driving IC;

FIG. 8 is a block diagram which shows an internal circuit of the data electrode driving IC;

FIG. 9 is a block diagram which shows a first exemplary internal circuit of the scan electrode driving IC;

FIG. 10 is a block diagram which shows an internal circuit of a scheduler section of the scan electrode driving IC with the first exemplary internal circuit;

FIG. 11 is a block diagram which shows an internal circuit of a driver section of the scan electrode driving IC;

FIG. 12 is a block diagram which shows a second exemplary internal circuit of the scan electrode driving IC; and

FIG. 13 is a block diagram which shows an internal circuit of a scheduler section of the scan electrode driving IC with the second exemplary internal circuit.

### DETAILED DESCRIPTION OF THE PREFERRED EMBODIMENTS

Embodiments of a liquid crystal display apparatus according to the present invention are described with reference to the accompanying drawings.

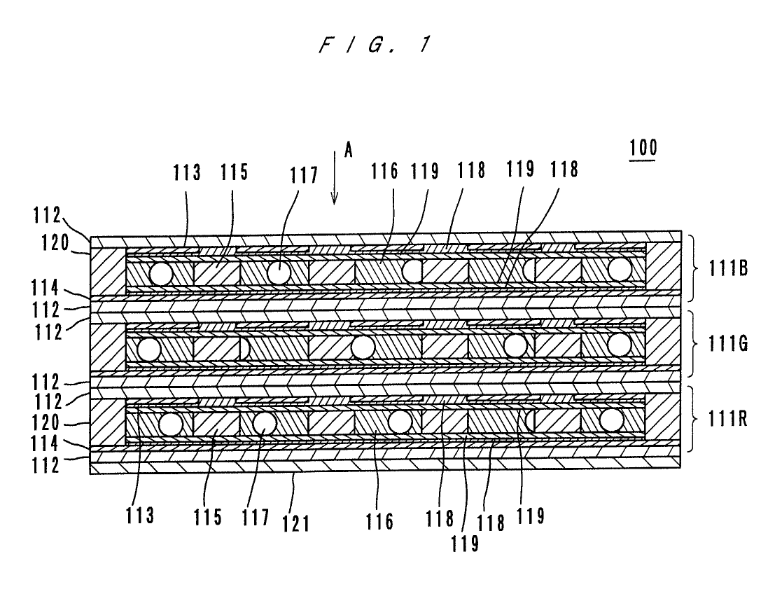

### Liquid Crystal Display; See FIG. 1

First, a liquid crystal display which is employed in a liquid crystal display apparatus is described. The liquid crystal display comprises liquid crystal which exhibits a cholesteric phase.

FIG. 1 shows a reflective type full-color liquid crystal display which is driven by a simple matrix driving method. In this liquid crystal display 100, on a light absorbing layer 121, a red display layer 111R, a green display layer 111G and a blue display layer 111B are laminated. The red display layer 111R makes a display by switching between a red selective reflection state and a transparent state. The green display layer 111G makes a display by switching between a green selective reflection state and a transparent state. The blue display layer 111B makes a display by switching between a blue selective reflection state and a transparent state.

Each of the display layers 111R, 111G and 111B has, between transparent substrates 112 on which transparent electrodes 113 and 114 are formed, resin columnar nodules 115, liquid crystal 116 and spacers 117. On the transparent electrodes 113 and 114, an insulating layer 118 and an alignment controlling layer 119 are provided if necessary. Around the substrates 112 (out of a displaying area), a sealant 120 is provided to seal the liquid crystal 116 therein.

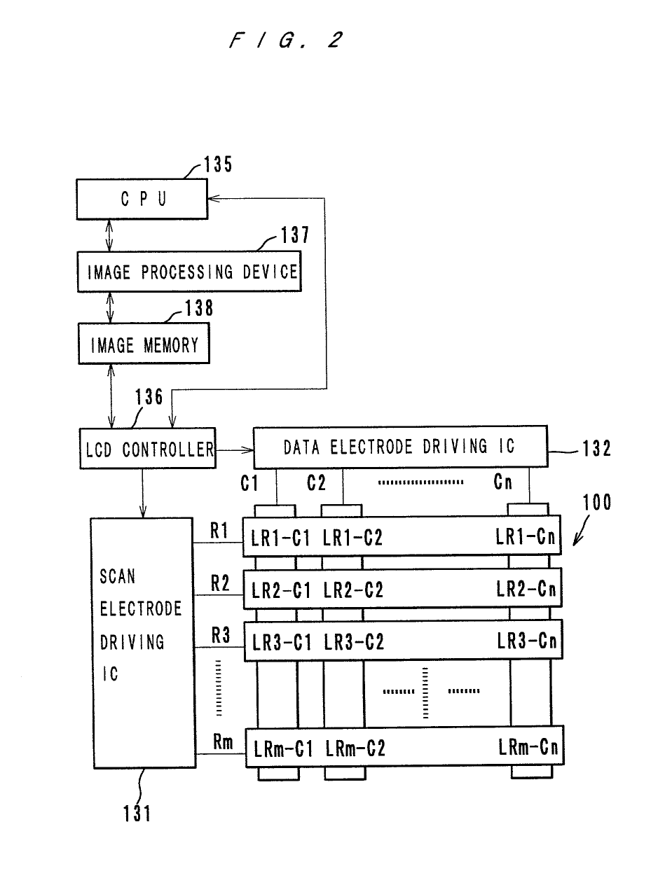

The transparent electrodes 113 and 114 are connected to driving ICs 131 and 132 respectively (see FIG. 2), and specified pulse voltages are applied between the transparent electrodes 113 and 114. In response to the voltages applied, the liquid crystal 116 switches between a transparent state to transmit visible light and a selective reflection state to selectively reflect light of a specified wavelength.

In each of the display layers 111R, 111G and 111B, the transparent electrodes 113 and 114, respectively, are composed of a plurality of strip-like electrodes which are arranged in parallel at fine intervals. The extending direction of the strip-like electrodes 113 and the extending direction of the strip-like electrodes 114 are perpendicular to each other, and the electrodes 113 and the electrodes 114 face each other. Electric power is applied between these upper electrodes and lower electrodes serially, that is, voltages are applied to the liquid crystal 116 serially in a matrix, so that the liquid crystal 116 makes a display. This is referred to as matrix driving. The intersections between the electrodes 113 and 114 function as pixels. By carrying out this matrix driving toward the display layers 111R, 111G and 111B serially or simultaneously, a full-color image is displayed on the liquid crystal display 100.

A liquid crystal display which has liquid crystal which exhibits a cholesteric phase between two substrates makes a display by switching the liquid crystal between a planar state and a focal-conic state. When the liquid crystal is in the planar state, the liquid crystal selectively reflects light of a wavelength λ=Pn (P: helical pitch of the cholesteric liquid crystal, n: average refractive index). When the liquid crystal display is in the focal-conic state, if the wavelength of light selectively reflected by the liquid crystal is in the infrared spectrum, the liquid crystal scatters light, and if the wavelength of light selectively reflected by the liquid crystal is shorter than the infrared spectrum, the liquid crystal transmits visible light. Accordingly, if the wavelength of light selectively reflected by the liquid crystal is set within the visible spectrum and if a light absorbing layer is provided in the side opposite the observing side of the display, the liquid crystal display makes displays as follows: when the liquid crystal is in the planar state, the liquid crystal display makes a display of the color determined by the selectively reflected light; and when the liquid crystal is in the focal-conic state, the liquid crystal display makes a display of black. Also, if the wavelength of light selectively reflected by the liquid crystal is set within the infrared spectrum and if a light absorbing layer is provided in the side opposite the observing side of the display, the liquid crystal display makes displays as follows: when the liquid crystal is in the planar state, the liquid crystal reflects infrared light but transmits visible light, and accordingly, the liquid crystal display makes a display of black; and when the liquid crystal display is in the focal-conic state, the liquid crystal scatters light, and accordingly, the liquid crystal display makes a display of white.

In the liquid crystal display 100 in which the display layers 111R, 111G and 111B are laminated, when the liquid crystal of the blue display layer 111B and the liquid crystal of the green display layer 111G are in the focal-conic state (transparent state) and when the liquid crystal of the red display layer 111R is in the planar state (selective reflection state), a display of red is made. When the liquid crystal display of the blue display layer 111B is in the focal-conic state (transparent state) and when the liquid crystal of the green display layer 111G and the liquid crystal of the red display layer 111R are in the planar state (selective reflection state), a display of yellow is made. Thus, by setting the display layers 111R, 111G and 111B in the transparent state or in the selective reflection state appropriately, displays of red, green, blue, white, cyan, magenta, yellow and black are possible. Further, by setting the display layers 111R, 111G and 111B in intermediate states, displays of intermediate colors are possible, and thus, the liquid crystal display 100 can be used as a full-color display.

The liquid crystal 116 preferably exhibits a cholesteric phase at room temperature. Especially chiral nematic liquid crystal which is produced by adding a chiral agent to nematic liquid crystal is suited.

A chiral agent is an additive which, when it is added to nematic liquid crystal, twists molecules of the nematic liquid crystal. When a chiral agent is added to nematic liquid crystal, the liquid crystal molecules form a helical structure with uniform twist intervals, and thereby, the liquid crystal exhibits a cholesteric phase.

However, the liquid crystal with a memory effect is not necessarily of this structure. It is possible to structure the liquid crystal display layer to be a polymer-dispersed type composite layer in which liquid crystal is dispersed in a three-dimensional polymer net or in which a three-dimensional polymer net is formed in liquid crystal.

### Driving Circuit; See FIG. 2

As FIG. 2 shows, the pixels of the liquid crystal display 100 are structured into a matrix which is composed of a plurality of scan electrodes R1, R2, . . . Rm and a plurality of data electrodes C1, C2, . . . Cn (n, m: natural numbers). The scan electrodes R1, R2 . . . Rm are connected to output terminals of the scan electrode driving IC 131, and the data electrodes C1, C2, . . . Cn are connected to output terminals of the data electrode driving IC 132.

The scan electrode driving IC 131 outputs a selective signal to a specified one of the scan electrodes R1, R2, . . . Rm while outputting a non-selective signal to the other scan electrodes R1, R2, . . . Rm. The scan electrode driving IC 131 outputs the selective signal to the scan electrodes R1, R2, . . . Rm one by one at specified time intervals. In the meantime, the data electrode driving IC 132 outputs signals to the data electrodes C1, C2, . . . Cn simultaneously in accordance with image data to write the pixels on the selected scan electrode. For example, while a scan electrode Ra (a≦m, a: natural number) is selected, the pixels LRa-C1 through LRa-Cn on the intersections of the scan electrode Ra and the data electrodes C1, C2, . . . Cn are written simultaneously. In each pixel, the voltage difference between the scan electrode and the data electrode is a voltage for writing the pixel (writing voltage), and each pixel is written in accordance with this writing voltage.

The driving circuit of the liquid crystal display 100 comprises a CPU 135, an LCD controller 136, an image processing device 137, an image memory 138 and the driving ICs (drivers) 131 and 132. In accordance with image data stored in the image memory 138, the LCD controller 136 controls the driving ICs 131 and 132. Thereby, voltages are applied between the scan electrodes and the data electrodes of the liquid crystal display 100 serially, so that an image is written on the liquid crystal display 100. The structures of the driving ICs 131 and 132 will be described in detail later.

Suppose the threshold voltage (first threshold voltage) to untwist liquid crystal which exhibits a cholesteric phase to be Vth1, when the first threshold voltage Vth1 is applied to the liquid crystal for a sufficiently long time and thereafter, the voltage is lowered under a second threshold voltage Vth2 which is lower than Vth1, the liquid crystal comes to a planar state. When a voltage which is higher than Vth2 and lower than Vth1 is applied to the liquid crystal for a sufficiently long time, the liquid crystal comes to a focal-conic state. These two states are maintained even after stoppage of application of voltage. Also, by applying voltages between Vth1 and Vth2 to the liquid crystal, it is possible to display intermediate tones, that is, gray levels.

Further, when writing part of the liquid crystal display, only specified scan electrodes including the part shall be selected. In this way, writing is carried out on only necessary part of the liquid crystal display, which requires a shorter time.

Writing can be carried out in the above-described way. If an image is displayed on the liquid crystal display, preferably, all the pixels are reset to the same state before writing a new image so that the newly written image will not be influenced by the previously displayed image. The reset of all the pixels may be carried out simultaneously or may be serially by scan electrode.

When writing is to be carried out on part of the liquid crystal display, the reset may be carried out by scan electrode, or the pixels on specified scan electrodes including the desired part may be reset at one time.

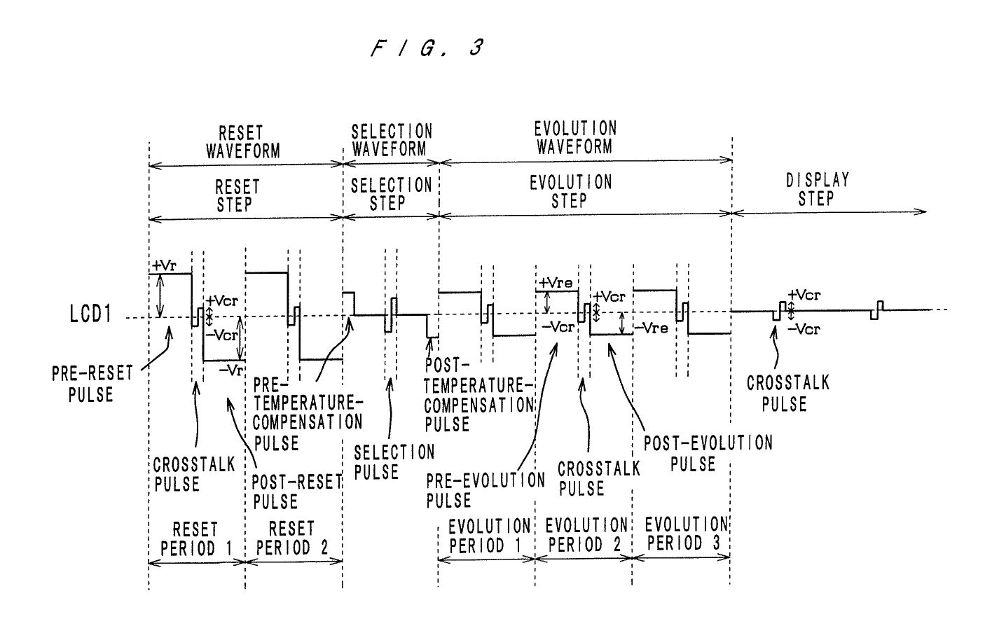

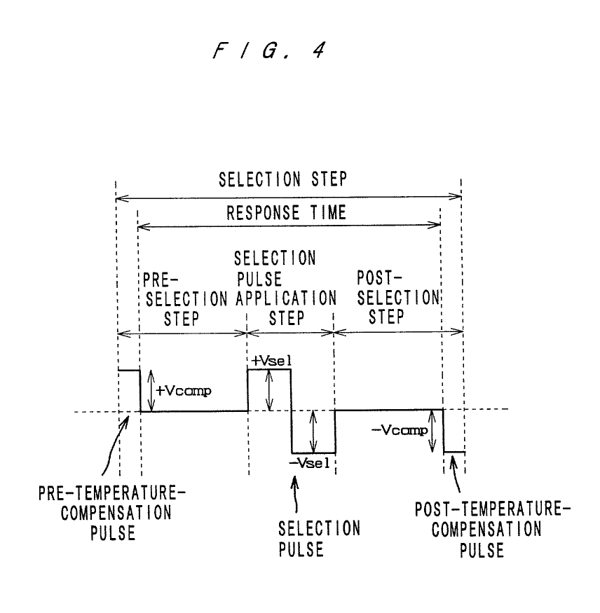

### Driving Method; See FIGS. 3 and 4

First, the fundamentals of a method of driving the liquid crystal display 100 is described. Although specific examples which use alternated pulse waveforms will be described in the following paragraphs, the driving method does not necessarily use such waveforms. As FIG. 3 shows, the driving method generally comprises a reset step, a selection step, an evolution step and a display step (which is also referred to as a crosstalk step).

The reset step is composed of a plurality of (approximately from 30 to 100) periods, each of which corresponds to the length of the selection step. In the case of FIG. 3, the reset step is composed of a reset period 1 and a reset period 2. In each of the reset periods, a pre-reset pulse of a voltage +Vr, a crosstalk pulse of a voltage ±Vcr and a post-reset pulse of a voltage −Vr are applied to the pixel. A stream of these pulses for a plurality of periods is referred to as a reset waveform.

In the same way, the evolution step is composed of a plurality of periods, and in the case of FIG. 3, the evolution step is composed of three periods. In each of the evolution periods, a pre-evolution pulse of a voltage +Vre, a crosstalk pulse of a voltage ±Vcr and a post-evolution pulse of a voltage −Vre are applied to the pixel. A stream of these pulses for a plurality of periods is referred to as an evolution pulse waveform.

In the display step, crosstalk pulses of a voltage ±Vcr act on the pixel. Also, it is possible to stop the driving ICs 131 and 132 to apply 0 volt when writing of an image is completed, that is, when all the pixels have gone through the evolution step.

As FIG. 4 shows, the selection step is composed of a pre-selection step, a selection pulse application step and a post-selection step, and in the pre-selection step, a pre-temperature-compensation pulse of a voltage +Vcomp is applied. The pre-selection step is divided into a time in which the pre-temperature-compensation pulse is applied and a time in which the pre-temperature-compensation pulse is not applied. In the selection pulse application step, a selection pulse of a voltage ±Vse1 is applied. The pulse width of the selection pulse is changed in accordance with image data. In the post-selection step, a post-temperature-compensation pulse of a voltage −Vcomp is applied, and the post-selection step is divided into a time in which the post-temperature-compensation pulse is applied and a time in which the post-temperature-compensation pulse is not applied.

Next, the state of liquid crystal is described. First, a reset waveform is applied in the reset step, and thereby, the liquid crystal is reset to a homeotropic state. Subsequently, while the pre-temperature-compensation pulse of a voltage +Vcomp is applied in the pre-selection step, the liquid crystal stays in the homeotropic state. After the application of the pre-temperature-compensation pulse, that is, while 0 volt is applied for the rest of the pre-selection step, the liquid crystal is twisted a little. Next, a selection pulse is applied in the selection pulse application step; the form of the selection pulse depends on whether the pixel is selected to finally come to a planar state or to finally come to a focal-conic state.

First, a case of selecting a planar state as the final state of a pixel is described. In this case, in the selection pulse application step, a selection pulse of a voltage ±Vse1 is applied, and thereby, the liquid crystal comes to a homeotropic state again. Thereafter, when the voltage is made zero in the post-selection step, the liquid crystal is untwisted a little. Then, the post-temperature-compensation pulse of a voltage −Vcomp is applied, and the evolution waveform is applied in the evolution step. Thereby, the liquid crystal, which has been untwisted a little in the post-selection step, is completely untwisted and comes to the homeotropic state.

Crosstalk pulses are applied to the liquid crystal in the display step; however, the pulse width of the crosstalk pulses is too narrow to change the state of the liquid crystal. The liquid crystal in the homeotropic state comes to a planar state when the voltage applied thereto becomes zero. Thereafter, while the voltage applied thereto is kept zero, the liquid crystal stays in the planar state.

In a case of selecting a focal-conic state as the final state of a pixel, 0 volt is applied to the liquid crystal in the selection pulse application step. In other words, the pulse width of the selection pulse is set to zero. Then, as in the case of selecting a planar state, in the post-selection step, 0 volt is applied. Thereby, the liquid crystal is untwisted and comes to a transient planar state taught by U.S. Pat. No. 5,748,277 in which the helical pitch is widened approximately double.

Thereafter, the post-temperature-compensation pulse −Vcomp is applied, and the evolution waveform is applied in the evolution step. The liquid crystal, which has been untwisted in the post-selection step, comes to a focal-conic state by the application of the post-temperature-compensation pulse and the evolution waveform. In the display step, as in the case of selecting a planar state, crosstalk pulses are applied to the liquid crystal; however, the pulse width is too small to change the state of the liquid crystal. The liquid crystal in a focal-conic state stays in the same state even while the voltage applied thereto is made zero.

As described above, the final state of the liquid crystal depends on the selection pulse applied in the selection pulse application step. Also, by adjusting the pulse width of the selection pulse, and more specifically by changing the form of the pulse applied to the data electrode in accordance with image data, intermediate tones can be displayed.

According to the above-described driving waveform, the time from the end of application of the pre-temperature-compensation pulse to the start of application of the post-temperature-compensation pulse is long enough that the liquid crystal can come to a transient planar state. In this specification, this time is referred to as a response time.

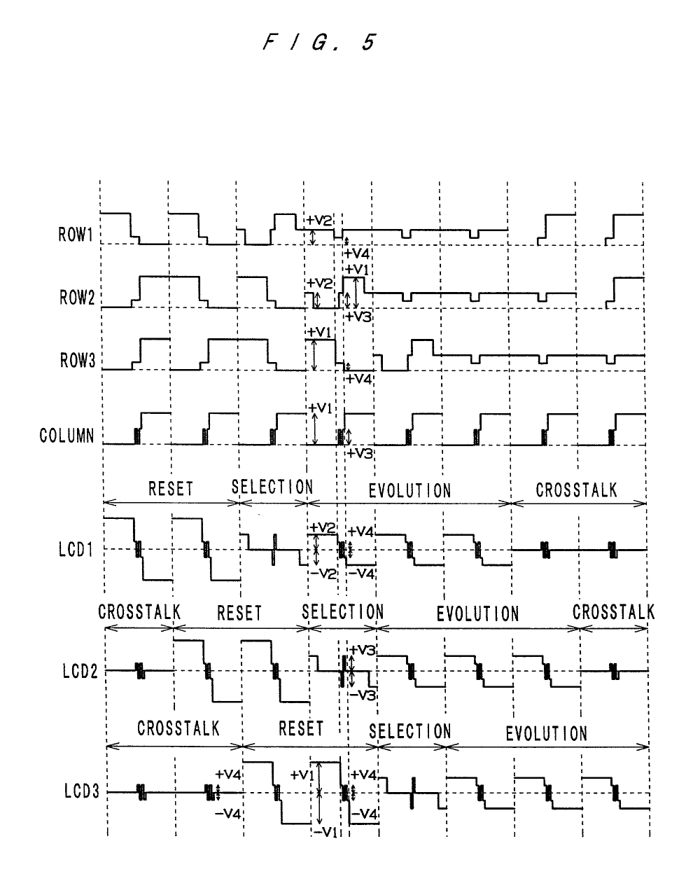

### Matrix Driving: See FIG. 5

FIG. 5 shows driving waveforms applied to a plurality of pixels LCD1, LCD2 and LCD3 which are arranged in a matrix and exemplary pulse waveforms applied to the scan electrodes (rows) and the data electrode (column) to achieve the driving waveforms. “ROW1”, “ROW2” and “ROW3” mean the lines on three scan electrodes, and “COLUMN” means the line on one data electrode.

In this driving method, as described above, the selection step is composed of a pre-selection step, a selection pulse application step and a post-selection step. In the pre-selection step, a pre-temperature-compensation pulse is applied, in the selection pulse application step, a selection pulse is applied, and in the post-selection step, a post-temperature-compensation pulse is applied. The pulse width of the selection pulse depends on image data. On the other hand, there are times to apply 0 volt to the liquid crystal in the pre-selection step and in the post-selection step. Therefore, a combination of waveforms applied to a row and a column to achieve 0 volt on the liquid crystal can be used for different processes. By using this, reset, evolution and display of a plurality of scan electrodes are carried out simultaneously.

Every pixel is driven by the potential difference between the voltage applied to the scan electrode and the voltage applied to the data electrode, and the above-described voltages have the following relationship:

Vr=V1

Vre=V2=½×V1

Vse1=V3

Vcr=V4=½×V3

For example, while the LCD2 is in the pre-selection step, voltages are applied to the rows as follows: the voltage +V2 is applied to the ROW2, and thereafter, the voltage is made zero; the voltage +V1 is applied to the ROW3; and the voltage +V2 is applied to the ROW1. At this time, by applying 0 volt to the COLUMN, a pre-reset pulse of the voltage +V1 acts on the LCD3; a pre-temperature-compensation pulse of the voltage +V2 acts on the LCD2, and an evolution pulse of the voltage +V2 acts on the LCD1.

While the LCD2 is in the selection pulse application step, a data pulse of the voltage +V3 with a pulse form in accordance with image data is applied to the COLUMN. Accordingly, in the meantime, the voltage +V4 is applied to the ROW1 and the ROW3 so that the voltage +V4 will act on the LCD1 and the LCD3. The voltage +V3 is applied to the ROW2 so that the voltage difference between the data pulse applied to the COLUMN and the voltage (±V3 or 0) will act on the LCD2 as a selection pulse. By changing the form of the data pulse, the pulse width of the selection pulse can be changed, and thereby, gray levels can be displayed.

Next, while the LCD2 is in the post-selection step, voltages are applied to the rows as follows: the voltage +V1 and the voltage +V2 are applied to the ROW2; 0 volt is applied to the ROW3; and the voltage +V2 is applied to the ROW1. At this time, by applying the voltage +V1 to the COLUMN, a post-reset pulse of the voltage −V1 acts on the LCD3, a post-temperature-compensation pulse of the voltage −V2 acts on the LCD2, and an evolution pulse of the voltage −V2 acts on the LCD1.

To a row (not shown) which is not in any of the reset step, the selection step and the evolution step, a pulse waveform of the voltage +V1 which is in phase with the data pulse applied to the COLUMN in the pre-selection step and in the post-selection step is applied, and while the row is in the selection pulse application step, the voltage ±V4 is applied. Thereby, a crosstalk pulse of the voltage ±V4 with the same pulse width as that of the selection pulse acts on the LCD in this part. The pulse width of the crosstalk pulse is too narrow to change the state of the liquid crystal.

Thereafter, the above-described steps are repeated, and thus, the reset waveform, the selection waveform and the evolution waveform are applied to desired lines (scan electrodes). Accordingly, partial writing on the liquid crystal display is possible.

In this driving method, the scan electrode driving IC 131 has five output levels (V1, V2, V3, V4 and GRD), and the data electrode driving IC 132 has three output levels (V1, V3 and GND).

As described, the scan electrodes and the data electrodes have mutually different functions. The data electrode driving IC 132 outputs pulses as shown by the COLUMN in FIG. 5 in accordance with data written and tone control. The scan electrode driving IC 131 outputs pulses of different waveforms for reset, selection, evolution and display as shown by the ROW1, ROW2 and ROW3 in FIG. 5.

In such a case in which the scan electrodes and the data electrodes have different functions, the number of reset pulses and the number of evolution pulses outputted from the scan electrode driving IC 131 may be several tens or several hundreds. Conventionally, one controller controls the sequences of the both driving ICs 131 and 132. In the following embodiments, however, the sequence controller is structured into a hardware logic, and an element with this function (for example, a scheduler section 253 or 253′ which will be described in detail later) is installed in the scan electrode driving IC 131. Thus, in the embodiments, the controller is simplified. The reasons for the simplification of the controller are as follows: the sequences of the driving ICs 131 and 132 are merely repetitions of a waveform; and in driving a large-scale display, the burden on the controller will greatly increase.

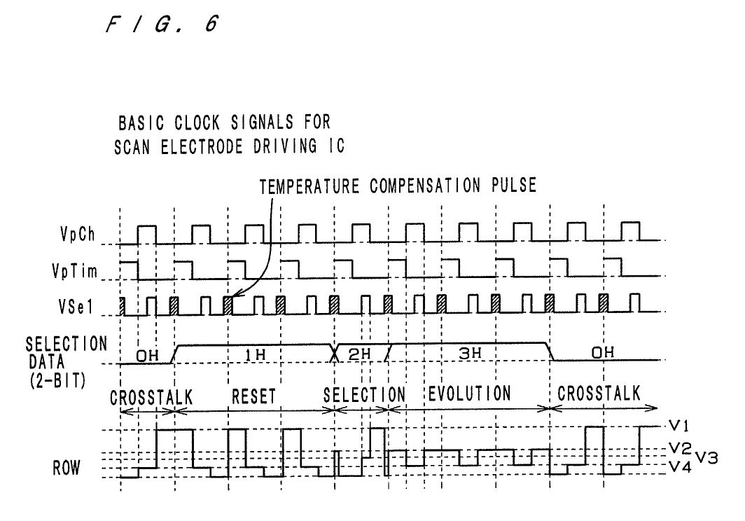

### First Embodiment; See FIGS. 6-11

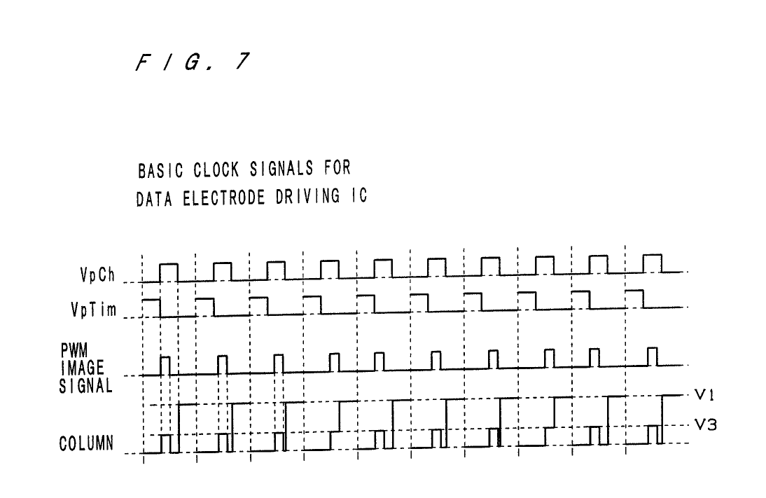

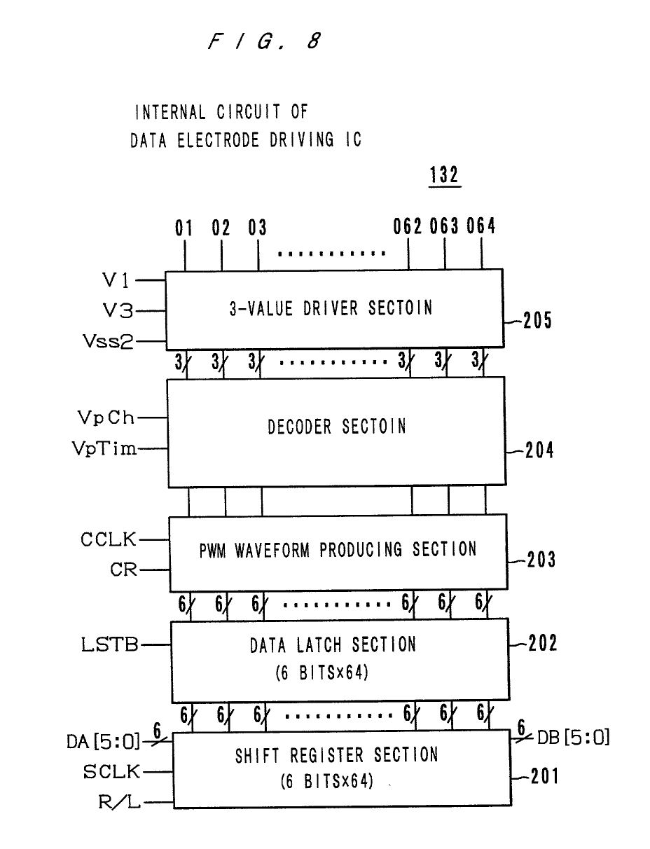

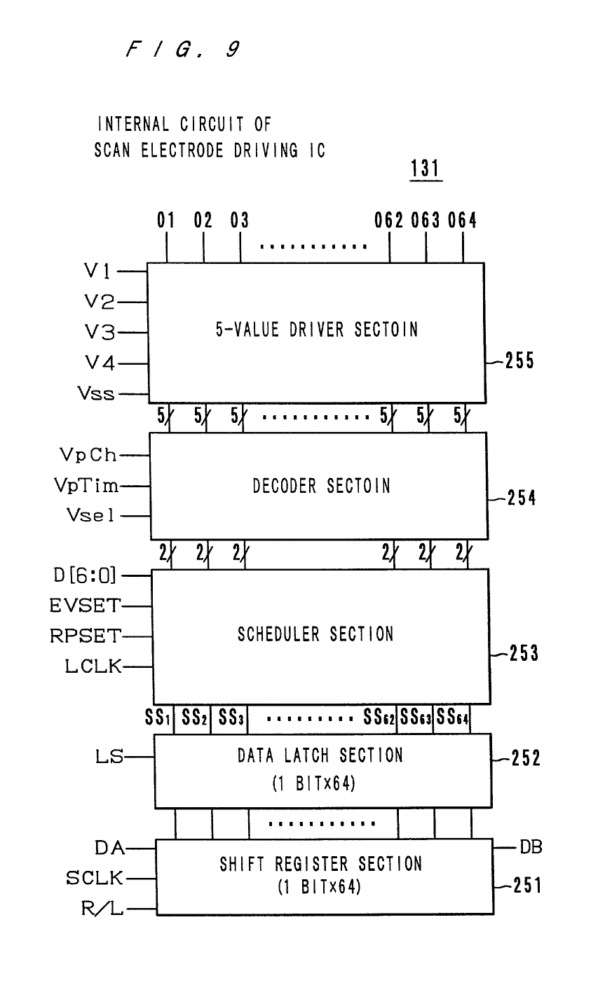

FIG. 6 shows basic clock signals to drive the scan electrode driving IC 131, and FIG. 7 shows basic clock signals to drive the data electrode driving IC 132. FIG. 8 shows the internal circuit of the data electrode driving IC 132, and FIG. 9 shows the internal circuit of the scan electrode driving IC 131.

First, the data driving IC 132 is described. As FIG. 8 shows, the data driving IC 132 comprises a shift register section 201, a data latch section 202, a PWM waveform producing section 203, a decoder section 204 and a three-value driver section 205 with a high withstand voltage.

As FIG. 5 shows, in the pre-selection step and in the post-selection step, the data driving IC 132 outputs a pulse waveform in phase with the pulse waveform applied to a selected scan electrode. In these steps, as FIG. 7 shows, when both the basic signals VpCh and VpTim are at a low level, the data driving IC 132 outputs the voltage V1. In the selection pulse application step, the data driving IC 132 outputs a pulse of which phase is shifted in accordance with image data. Tables 1-3 are truth tables of the data driving IC 132. In these tables, the mark “↑” means the rising edge of a signal, and the mark “X” means that the signal is either at a low level or at a high level. Further, in the notes of Table 1, Sm(n) (0≦m≦64, 0≦n≦5) means the nth bit in the mth shift register.

TABLE 1
(Column, Shift Register Section & Data Latch Section)

| Input | | | Input/Output | | Shift | |
|---|---|---|---|---|---|---|
| R/L | SCLK | LSTB | DA[5:0] | DB[5:0] | Register | Latch |
| H | ↑ | H or L | input | output | RIGHT | retain previous |
| | | | | *1 | shift | values |
| H | H or L | H or L | | output | retain | retain previous |
| | | | | | | values |
| H | H or L | ↑ | | output | retain | latch values of |
| | | | | | | shift register |
| L | ↑ | H or L | output | input | execution | retain previous |
| | | | *2 | | of LEFT | values |
| | | | | | shift | |
| L | H or L | H or L | output | | retain | retain previous |
| | | | | | | values |
| L | H or L | | output | | retain | latch values of |
| | | | | | | shift register |

*1: At the rising edge of SCLK, values in S63(0) to S63(5) are shifted to S64(0) to S64(5) and outputted from DB[5:0].
*2: At the rising edge of SCLK, values in S2(0) to S2(5) are shifted to S1(0) to S1(5) and outputted from DA[5:0].

TABLE 2
(Column, PWM Waveform Producing Section)

| CCLK | CR | Counter | Comparator Section | EX-OR Section |
|---|---|---|---|---|
| ↑ | H | Increment | counter value | counter value > |
| | | 00(H)→01(H) | (lowest 6 bits) ≦ | data value and |
| | | 01(H)→02(H) | data value: L | counter value ≦ |
| | | : | counter value | data value + 64: H |
| | | : | (lowest 6 bits) ≦ | counter value ≦ |
| | | : | data value: H | data value or |
| | | 7E(H)→7F(H) | | counter value > |
| | | 7F(H)→00(H) | | data value + 64: L |
| X | L | counter reset | H | L |
| | | →7F(H) | (If counter value is | |
| | | | 7F(H), the output is | |
| | | | L regardless of the | |
| | | | data value.) | |

TABLE 3
(Column, Decoder Section and Three-value Driver Section)

| | | |
|---|---|---|
| VpCh | L | H |

| | | | | | |
|---|---|---|---|---|---|
| PWM | VpTim | L | H | L | H |

| | | | | |
|---|---|---|---|---|
| L | V1 | GND | GND | GND |
| H | V1 | GND | V3 | V3 |

Next, the scan electrode driving IC 131 is described. As FIG. 9 shows, the scan electrode driving IC 131 comprises a shift register section 251, a data latch section 252, a scheduler section 253, a decoder section 254 and a five-value driver section 255 with a high threshold voltage.

As FIG. 6 shows, the scan electrode driving IC 131 produces a driving waveform by combining signals VpCh, VpTim, Vse1 and two-bit selection data with each other and by decoding these signals. Tables 4-8 are truth tables of the scan electrode driving IC 131. In the notes of Table 4, “Sm” (0≦m≦64) means the mth shift register.

TABLE 4
(Row, Shift Register & Data Latch Section)

| Input | | | Input/Output | | Shift | |
|---|---|---|---|---|---|---|
| R/L | SCLK | LSTB | DA | DB | Register | Latch |
| H | ↑ | H or L | input | output | RIGHT | retain previous |
| | | | | *1 | shift | values |
| H | H or L | H or L | | output | retain | retain previous |
| | | | | | | values |
| H | H or L | ↑ | | output | retain | latch values of |
| | | | | | | shift register |
| L | ↑ | H or L | output | input | execution | retain previous |
| | | | *2 | | of LEFT | values |
| | | | | | shift | |
| L | H or L | H or L | output | | retain | retain previous |
| | | | | | | values |
| L | H or L | | output | | retain | latch values of |
| | | | | | | shift register |

*1: At the rising edge of SCLK, a value in S63 is shifted to S64 and outputted from DB.
*2: At the rising edge of SCLK, a value in S2 is shifted to S1 and outputted from DA.

TABLE 5
(Row, Latch of Scheduler Section)

| DA[6:0] | RPSET | EVSET | RP Latch | EV Latch |
|---|---|---|---|---|
| D[6:0] | L | — | D[6:0] | — |
| D[6:0] | — | L | — | complement of 2 of |
| | | | | D[6:0] |

TABLE 6
(Row, Counter of Scheduler Section)

| LCLK | STOP | SSn | Counter |
|---|---|---|---|
| X | X | L | RS latch data load & count stop |
| ↑ | L | H | count down |
| X | H | H | count stop |

TABLE 7
(Row, Encoder of Scheduler Section)

| Counter Value | SSn | STOP | Encoder |
|---|---|---|---|
| X | L | L | display (L, L) output |
| >0 | H | L | reset (L, H) output |
| =0 | H | L | selection (H, H) |
| <0 | H | L | evolution (H, L) |
| =EV data | X | H | display (L, L) |

TABLE 8
(Row, Decoder Section & Five-value Driver Section)

| Truth Table | Vch | | L | L | H | H |
|---|---|---|---|---|---|---|
| output of encoder | Vse2 | VpTim | L | H | L | H |

| | | | | | |
|---|---|---|---|---|---|
| display = LL | L | V1 | GND | V4 | V4 |
| display = LL | H | V1 | GND | V4 | V4 |
| reset = LH | L | GND | V1 | V4 | V4 |
| reset = LH | H | GND | V1 | V4 | V4 |
| selection = HL | L | V1 | GND | GND | GND |
| selection = HL | H | V2 | V2 | V3 | V3 |
| evolution = HH | L | V2 | V2 | V4 | V4 |
| evolution = HH | H | V2 | V2 | V4 | V4 |

Conventionally, two-bit selection data are produced and controlled by an external controller 136, and the data are inputted to the scan electrode driving IC 131 at every cycle of scanning so that the scan electrode driving IC 131 can output a necessary voltage. In the first embodiment, however, this function is imparted to the scan electrode driving IC 131, and thereby, the controller 136 can be simplified.

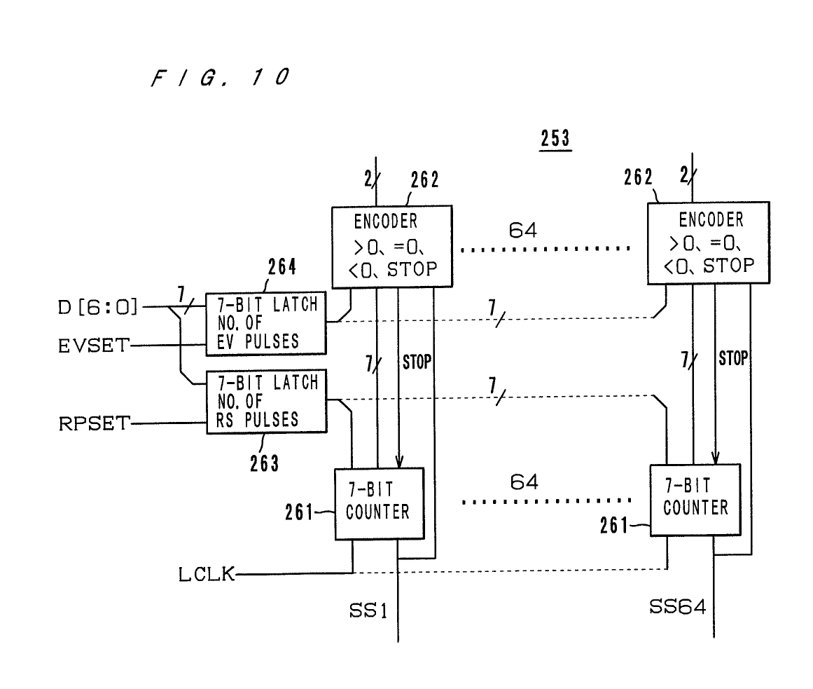

As FIG. 10 shows, in the scheduler section 253, for each of the output terminals, a 7-bit down counter 261, an encoder 262, a 7-bit latch 263 which records the number of reset pulses and a 7-bit latch 264 which records the number of evolution pulses are provided.

Next, the operation is described. First, the number of RS (reset) pulses is set in the latch 263. Simultaneously, the number of EV (evolution) pulses is set in the latch 264, and the number is a minus number. Next, when a signal SSn (n=1-64) is 0, the 7-bit counter 261 presets the number of RS pulses therein, and when SSn becomes 1, the 7-bit counter 261 starts counting down. The encoder 262 encodes the counter value in the way shown by Table 7, and thus, the schedule is controlled. Specifically, when the counter value becomes 0, the selection step is started, and when the counter value becomes minus, the evolution step is started. Then, when the counter value reaches the set number of EV pulses, a signal STOP is set to a high level to stop the counter 261. Thereby, the evolution step is completed, and the display step starts.

At the start of serial selection of the scan electrodes, data are shifted to the shift register section 251 and are latched in the data latch section 252 (see FIG. 9). The signal SSn of 1 is sent to the counter 261 for a scan electrode to be selected, and the counter 261 starts counting. The signal SSn for the selected scan electrode retains 1 until the counting is completed. On completion of the counting, the value of the SSn in the data latch section 252 is reset to 0. When selecting another scan electrode, the number of RS pulses and the number of EV pulses are set in the 7-bit counters 263 and 264 for the scan electrode to be next selected. Then, when the SSn for the next scan electrode becomes 1, the corresponding counter 261 starts counting. In this way, this process is repeated.

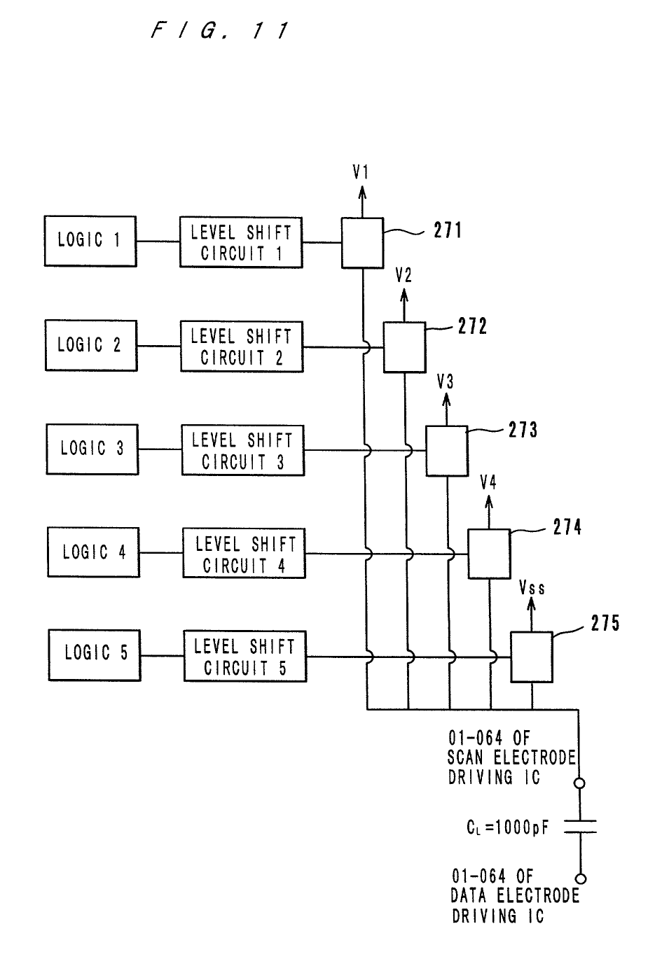

In the driver section 255, as FIG. 11 shows, analog switches 271 through 275 are turned on and off by level shift circuits 1 through 5, and thus, it is possible to output voltages V1, V2, V3 V4 and Vss selectively.

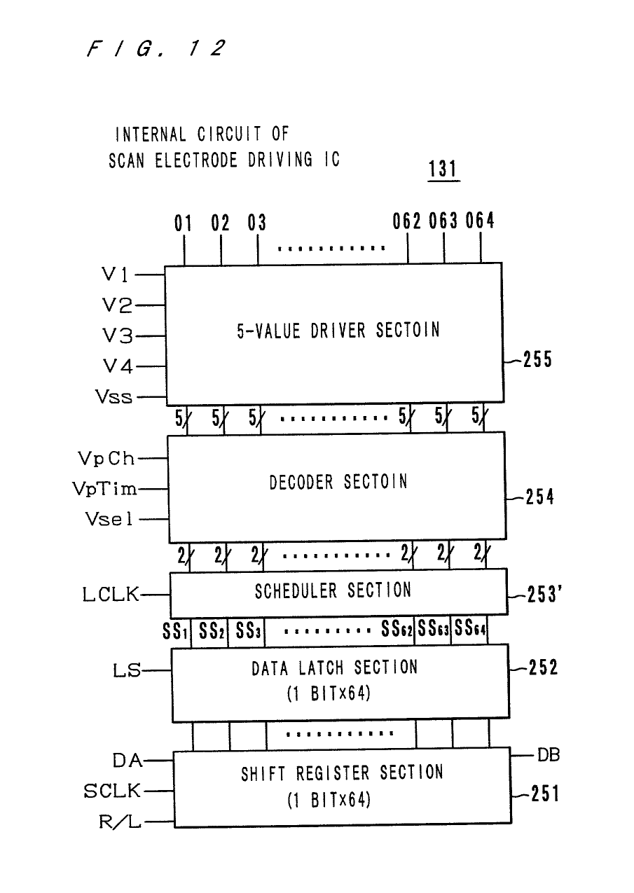

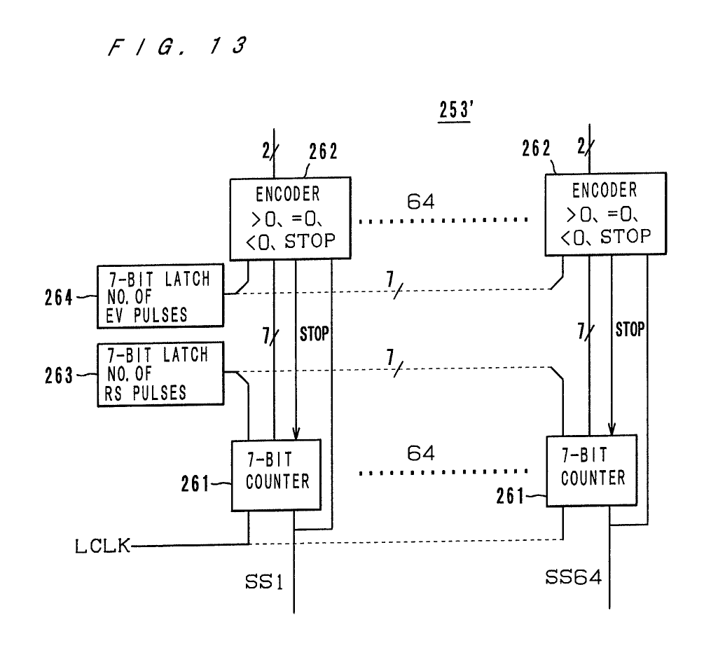

### Second Embodiment; See FIGS. 12 and 13

In the first embodiment, the number of reset pulses and the number of evolution pulses can be set by an external device (controller 136). In the second embodiment, the number of reset pulses and the number of evolution pulses were set in the scan driving IC 131 beforehand as fixed values. FIG. 12 shows an internal circuit of the scan electrode driving IC 131 used in the second embodiment, and FIG. 13 shows a scheduler section 253′ of the internal circuit.

As is apparent from FIG. 13, in the second embodiment, the signals DA [6:0], EVSET and PRSET which are used for setting of the number of reset pulses and the number of evolution pulses are not sent from outside (the controller 136) to the latches 263 and 264 of the scheduler section 253′.

### Other Embodiments

The structure, the materials and the producing method of the liquid crystal display are arbitrary. The voltage values of the pulse waveforms to drive the liquid crystal display are merely examples.

Although the present invention has been described in connection with the preferred embodiments above, it is to be noted that various changes and modifications are possible to those who are skilled in the art. Such changes and modifications are to be understood as being within the scope of the present invention.

What is claimed is:

1. A liquid crystal display apparatus comprising:
a liquid crystal display which comprises liquid crystal, and a plurality of scan electrodes and a plurality of data electrodes which face and cross each other with the liquid crystal in-between, the scan electrodes and the data electrodes defining a plurality of display units;
a scan electrode driving circuit which is connected to the scan electrodes and which outputs a stream of first pulses to each of the scan electrodes;
a data electrode driving circuit which is connected to the data electrodes and which outputs a stream of second pulses to each of the data electrodes; and
a control circuit which is connected to the scan electrode driving circuit and the data electrode driving circuit to control the scan electrode driving circuit and the data electrode driving circuit, the control circuit outputting a clock signal to the scan electrode driving circuit;
wherein the scan electrode driving circuit controls output timings of the first pulses to each of the scanning electrodes based on the clock signal.

2. The liquid crystal display apparatus according to claim 1, wherein the scan electrode driving circuit controls the output timings of the first pulses by encoding the clock signal in accordance with a first rule and by decoding the encoded clock signal in accordance with a second rule.

3. The liquid crystal display apparatus according to claim 1, wherein the streams of first pulses outputted to the respective scan electrodes are out of phase with each other.

4. The liquid crystal display apparatus according to claim 1, wherein the liquid crystal exhibits a cholesteric phase.

5. The liquid crystal display apparatus according to claim 4, wherein the liquid crystal display displays an image by using a selective reflection characteristic of the liquid crystal which exhibits a cholesteric phase when the liquid crystal is in a planar state.

6. The liquid crystal display apparatus according to claim 5, wherein the liquid crystal exhibits bistability between a planar state and a focal-conic state.

7. The liquid crystal display apparatus according to claim 6, wherein the stream of first pulses is applied to each of the scan electrodes during the following steps:
a first step of causing the liquid crystal to come to a homeotropic state;
a second step, after the first step, of selecting a planar state, a focal-conic state or an intermediate state between the planar state and the focal-conic state as a final state of the liquid crystal; and
a third step, after the second step, of causing the liquid crystal to evolve to the selected final state.

8. The liquid crystal display apparatus according to claim 7, wherein a number of pulses to be outputted during at least one of the first, second and third steps can be set outside the scan electrode driving circuit.

9. The liquid crystal display apparatus according to claim 7, wherein a number of pulses to be outputted during at least one of the first, second and third steps is set as a fixed value beforehand in the scan electrode driving circuit.
